(19) United States
(12) Patent Application Publication
(10) Pub. No.: US 2014/0314603 A1
(43) Pub. Date: Oct. 23, 2014

(54) FUEL PUMP

(71) Applicant: HITACHI. LTD, Tokyo (JP)

(72) Inventors: Akira Inoue, Farmington Hills, MI (US); Harsha Badarinarayan, Canton, MI (US); Yosuke Tanabe, West Bloomfield, MI (US); Masanori Watanabe, Ibaraki-ken (JP)

(73) Assignee: Hitachi. Ltd, Tokyo (JP)

(21) Appl. No.: 13/868,350

(22) Filed: Apr. 23, 2013

(51) Int. Cl. F02M 21/02

(52) U.S. Cl. CPC F02M 21/0233
USPC 417/510; 417/567

(57) ABSTRACT

A fuel pump having a housing which defines a pump chamber with an inlet and an outlet. A piston is reciprocally mounted in the pump chamber. An inlet valve is mounted fluidly in series between the pump chamber and the housing inlet which opens and closes the inlet in synchronism with the reciprocation of the piston. A rotary valve is mounted fluidly in series with the housing outlet and the rotary outlet valve is rotatably driven in synchronism with reciprocation of the piston. The rotary valve is configured so that it is fluidly open only at one or more predetermined angular positions of the rotary outlet valve. The open and close timings of the rotary inlet and outlet valves are completely controlled by a motor in order to control the fuel pressure, especially to avoid excessive fuel compression and resulting fuel pressure fluctuation.

### BACKGROUND OF THE INVENTION

I. Field of the Invention

The present invention relates generally to fuel pumps and, more particularly, to a fuel pump for an automotive vehicle.

II. Description of Related Art

Internal combustion engine automotive vehicles necessarily include a fuel pump for pumping fuel from a fuel tank and to the cylinders for the internal combustion engine. Although there are many different types of internal combustion engines, direct injection internal combustion engines have enjoyed increased popularity in the automotive industry.

In a direct injection internal combustion engine, the fuel injector is mounted in the engine block so that it injects fuel directly into the combustion chambers or cylinders for the engine as compared to different types of internal combustion engines, such as a multi-point fuel injected internal combustion engine, direct injection internal combustion engines enjoy increased fuel economy and increased engine efficiency.

In order to supply fuel to the fuel injectors for a direct injection internal combustion engine, a fuel pump has its inlet fluidly connected to the fuel tank of the vehicle and its outlet fluidly connected to a fuel rail which extends over or near the fuel injectors for the engine. The fuel rail, in turn, is fluidly coupled to each fuel injector so that pressurized fuel is provided to each fuel injector. The fuel injectors themselves are electrically controlled by an engine control unit (ECU).

In order to inject fuel directly into the combustion chambers of the engine, the fuel rail must necessarily be maintained at a sufficiently high pressure to overcome the pressure of the engine combustion chambers during the time of the fuel injection.

Although different types of fuel pumps may be utilized to pump fuel from the fuel tank and create the high pressure required in the fuel rails, in one type of previously known fuel pump the fuel pump includes a housing defining a pump chamber. An inlet to the pump chamber is fluidly connected to the fuel tank while an outlet from the fuel chamber is fluidly connected to the fuel rail for the engine.

In order to create the high pressure required in the fuel rail, a piston is reciprocally mounted in the pump chamber and is reciprocally driven, typically in synchronism with rotation of the engine, by a cam drive. A solenoid valve is then fluidly connected in series with the inlet to the pump chamber and is movable between an open and closed position by the ECU so that the inlet is open as the piston reciprocates outwardly from the pump chamber and closes during the opposite stroke of the piston, i.e. movement of the piston into the pump chamber. A check valve is also fluidly connected in series with the pump outlet so that the check valve only opens during the piston stroke into the pump chamber, i.e. during pressurization of the pump chamber.

While these fuel pumps have proven adequate in operation for supplying fuel to the fuel rail for a direct injection internal combustion engine, the previously known fuel pumps tend to be noisy in operation. Indeed, the fuel pump noise is oftentimes perceptible at idle and low engine speeds.

Although there a number of different sources of the fuel pump noise, one source of the noise is attributable to the solenoid operated inlet valve which opens and closes during each reciprocation of the piston in the pump chamber. It is believed that this noise is due in large part to the impact of the inlet valve against the pump housing each time the inlet valve is moved to its closed position by the solenoid.

A still further source of noise in the fuel pump is attributable to the opening and closure of the check valve arranged fluidly in series at the pump chamber outlet between the pump chamber and the fuel rail. Due to the current mechanism of the outlet check valve, which is typically urged towards its closed position by a compression spring, compressed fuel pressure significantly in excess of the fuel pressure in the fuel rail is required to move the check valve from its closed to its open position. That excess pressure creates a fuel pressure pulsation in the overall fuel system which, in turn, results in audible noise. In addition, the impact of the check valve against the fuel pump housing as it moves to its closed position also contributes to the overall noise from the fuel pump.

### SUMMARY OF THE PRESENT INVENTION

The present invention provides a fuel pump design which overcomes the above-mentioned disadvantages of the previously known fuel pumps.

In brief, the fuel pump of the present invention includes a housing which defines a pump chamber having an inlet and an outlet. The inlet is fluidly connected to a source of fuel, such as a fuel tank, while the outlet is fluidly connected to the fuel injectors for the engine, typically through a fuel rail. The fuel pump of the present invention is particularly advantageous in use with a direct injection internal combustion engine of the type used in automotive vehicles.

A piston is reciprocally slidably mounted in the pump chamber so that reciprocation of the piston in the pump chamber varies the volume of the pump chamber. For example, when the piston stroke is away from the pump chamber the overall volume of the pump chamber increases and vice versa.

An inlet valve is fluidly mounted in the pump chamber inlet so that the inlet valve is fluidly in series between the source of fuel and the pump chamber. Similarly, an outlet valve is mounted in the pump chamber outlet so that the outlet valve is fluidly connected in series between the pump chamber and the fuel injectors. In the conventional fashion, the inlet valve opens as the piston stroke extends away from the pump chamber so that the piston inducts fuel from the fuel tank into the pump chamber. The inlet valve then closes so that during the opposite stroke of the piston, i.e. the piston extending into the pump chamber, the outlet valve opens and the piston pumps pressurized fluid to the fuel rail.

Unlike the previously known fuel pumps, however, both the inlet valve and the outlet valve are rotary valves which rotate in synchronism with the reciprocation of the piston in the pump chamber. Preferably, the rotary inlet valve and rotary outlet valve are mechanically coupled together, such as by a shaft extending across the pump chamber between the inlet valve and the outlet valve.

Any mechanism may be utilized to rotatably drive the rotary inlet and outlet valves. For example, a DC controllable motor or stepper motor may be used to rotatably drive the inlet and outlet valves under control of the ECU. Alternatively, the rotary inlet and outlet valves may be mechanically coupled to the drive mechanism for the piston and thus automatically synchronize with the reciprocation of the piston in the fuel chamber.

Both the inlet and outlet rotary valves are preferably cylindrical in shape and both include an axially extending recess at at least one predetermined angular position of the cylindrical valve. The axially extending recess then registers with both the inlet to the fuel pump chamber and the pump chamber during the outward movement or intake stroke of the piston from the pump chamber. In doing so, fuel is inducted through the inlet valve recess from the fuel tank and into the pump chamber.

Similarly, the outlet valve is also preferably cylindrical in shape and includes one axially extending recess at a predetermined angular position of the output valve. This recess registers with both the pump outlet and the pump chamber during the compression stroke of the piston, i.e. when the piston movement is into the pump chamber.

Since the excessive fuel compression and the resulting fuel pressure pulsation and fluctuation caused by the previously known check valves in the outlet of the previously known fuel pumps is eliminated (or minimized) by actively controlling the inlet and outlet valves, noise (sound and vibration) resulting from such pressure pulsations is also eliminated or at least reduced. Furthermore, since the rotary inlet and outlet valves merely rotate within their respective seats in the pump housing, the previously known noise (sound and vibration) caused by impact of both the inlet valve and outlet valve against the pump housing is eliminated.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a cross-sectional view illustrating a preferred embodiment of the fuel pump of the present invention;

FIG. 2 is an elevational view illustrating the inlet and outlet valves;

FIG. 3 is an axial view of the outlet valve in a closed position;

FIGS. 4A and 4B are axial end views of the inlet valve in the open and closed positions respectively;

FIGS. 5A and 5B are elevational fragmentary views illustrating the piston; and

FIG. 6 is an end view illustrating a modification of the inlet or outlet valve.

### DETAILED DESCRIPTION OF PREFERRED EMBODIMENTS OF THE PRESENT INVENTION

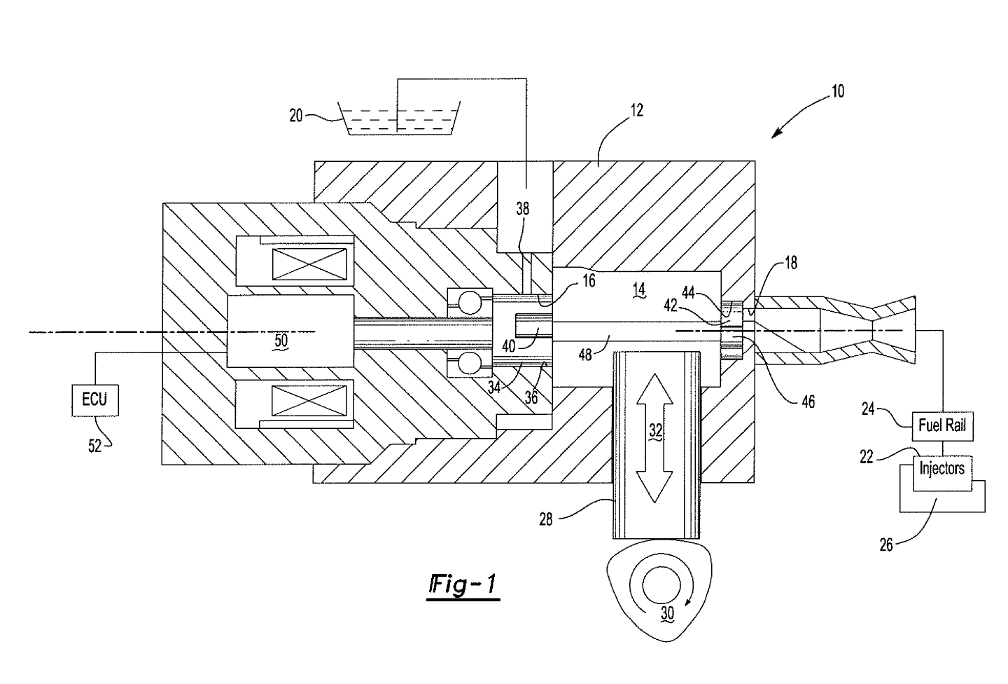

With reference first to FIG. 1, a fuel pump 10 according to the present invention is shown having a housing 12. The fuel pump defines an internal pump chamber 14 having an inlet 16 and an outlet 18.

The fuel pump inlet 16 is fluidly connected to a source 20 of fuel, such as a fuel tank. Conversely, the housing outlet 18 is fluidly connected to one or more fuel injectors 22, preferably through a fuel rail 24. The fuel injectors 22, in turn, supply fuel to an internal combustion engine 26 (illustrated only diagrammatically) which is preferably a direct injection internal combustion engine.

A piston 28 is reciprocally mounted to the fuel pump housing 12. Although any means may be used to reciprocally drive the piston 28, preferably a multi-lobe cam 30 is mechanically coupled to the piston 28. The cam 30 is preferably mechanically coupled to the drive shaft for the engine 26 so that the cam 30 rotates in synchronism with the engine rotation.

Rotation of the cam 30 reciprocally drives the piston 28 as indicated by arrow 32. Consequently, the piston 28 reciprocates between a pressure or compression stroke in which the piston 28 moves in a direction into the pump chamber 14 and an induction stroke in which the piston 28 moves outwardly from the pump chamber 14.

With reference now to FIGS. 1, 2, 4A and 4B, a rotary inlet valve 34 is rotatably mounted within a cylindrical recess 36 formed in the pump housing 12. This recess 36, furthermore, is fluidly positioned in between a fuel inlet passage 38 fluidly connected to the inlet 16 and the pump chamber 14.

The fuel inlet valve 34 is generally cylindrical in shape but includes a radially inwardly extending recess 40 at a predetermined angular position of the valve 34. Consequently, at a predetermined angular position for the rotary valve 34 illustrated in FIG. 4A, the opening 40 registers with both the fuel inlet passageway 38 and the pump chamber 14 to establish fluid communication between the pump chamber 14 and the source 20 of fuel. Conversely, at other rotational positions such as shown in FIG. 4B, the valve 34 closes the inlet passageway 38 from the pump chamber 14.

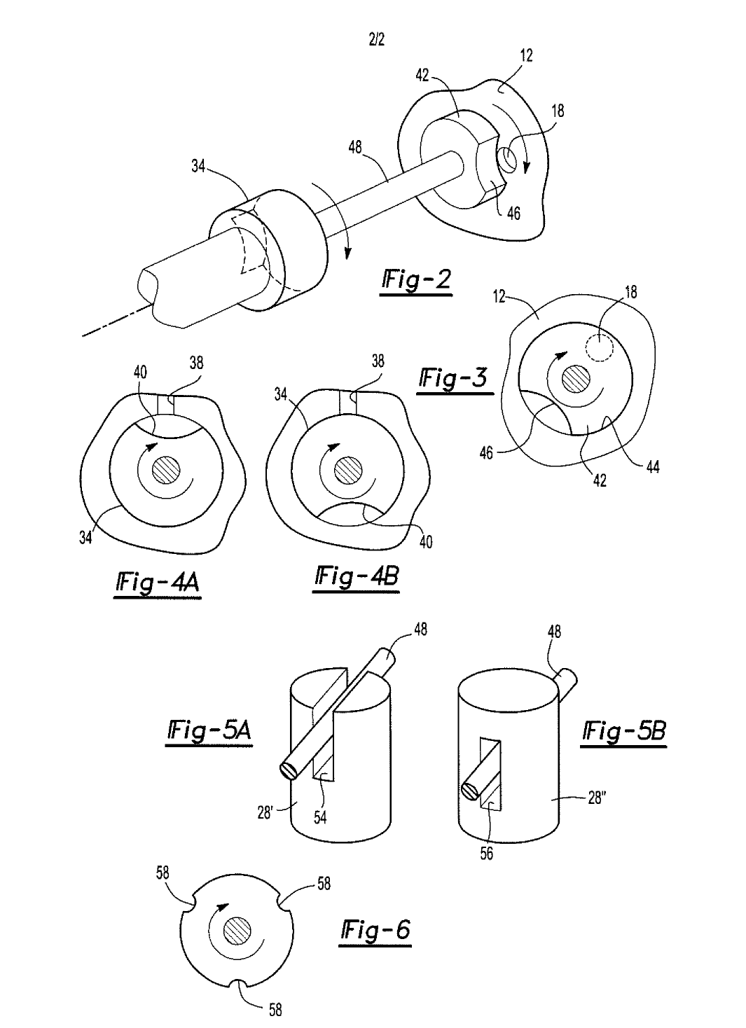

Similarly, with reference to FIGS. 1, 2, and 3, a generally cylindrical outlet valve 42 is rotatably mounted within a cylindrical recess 44 in the housing 14 which is fluidly in series between the fuel pump outlet 18 and the pump chamber 14. The rotary outlet valve 42, like the inlet valve 34, also includes a radially inwardly extending recess 46 at a predetermined angular position of the outlet valve 42. Thus, at predetermined rotational positions of the outlet valve 42 the opening 46 registers with both the outlet 18 and the pump chamber 14 as shown in FIG. 2 to establish fluid communication from the pump chamber 14 and to the fuel injectors 22 through the outlet 18 and fuel rail 24. At other rotational positions, such as shown in FIG. 3, the recess 46 does not register with the outlet 18 thus fluidly closing the pump chamber 14 from the outlet 18.

The rotation of the inlet valve 34 and outlet valve 42 within their respective valve seats 36 and 44, respectively, are synchronized with each other. Although different means may be used to synchronize the rotation of the inlet valve 34 with the outlet valve 42, as illustrated in FIGS. 1 and 2, a shaft 48 extends across the pump chamber 14 and is connected at one end to the inlet valve 34 and at its other end to the outlet valve 42. In doing so, the inlet valve 34 and outlet valve 42, which may be a one piece construction, are rotationally mechanically synchronized.

The rotation of the inlet valve 34 and outlet valve 42 is synchronized with the reciprocation of the piston 28 so that the opening 40 of the inlet valve 34 fluidly connects the fuel pump inlet 16 to the pump chamber 14 only during the induction or outward stroke of the piston 28. Similarly, the opening 46 in the outlet valve 42 fluidly connects the pump chamber 14 to the fuel outlet 18 only during the compression or inward stroke of the piston 28 into the fuel chamber 14.

With reference to FIG. 1, although different means may be utilized to rotatably drive the inlet valve 34 and outlet valve 42 in synchronism with the reciprocation of the piston 28, preferably a controllable motor 50, such as a DC controllable motor or stepper motor, mechanically synchronizes the rotation of the inlet valve 34 and outlet valve 42 with reciprocation of the piston 28 under control of the engine control unit (ECU) 52, other means may also be utilized to synchronize the rotation of the valves 34 and 42 with the piston 32. For example, the valves 34 and 42 may be mechanically coupled to the drive mechanism for the cam 30 in order to achieve synchronism between the valve opening and the piston reciprocation.

With reference now to FIGS. 5A and 5B, FIG. 5A illustrates an alternate design for the piston 28′ in which the piston 28′ includes a through notch 54. This through notch 54 is greater in width than the diameter of the shaft 48 so that portions of the piston 28′ extend around the shaft 48 during reciprocation of the piston 28′. Similarly, a modified piston 28″ is illustrated in FIG. 5B in which a closed through notch 56 is formed through the piston 28″. The shaft 48 extends through this through notch 56.

The inlet valve 34 and outlet valve 42 thus far described contain a single opening or notch 40 or 46, respectively. As such, as thus far described, the inlet valve 34 and outlet valve 42 rotate once for each full reciprocation of the piston 28 in the pump chamber 14. However, as shown in FIG. 6, two or more circumferentially equidistantly spaced notches, such as three notches 58, may be provided in the inlet valve 34′ and the outlet valve 42′. Where multiple notches or openings are formed in the inlet valve 34′ and outlet valve 42′, the inlet valve 34′ and outlet valve 42′ open three times during a single rotation of the inlet valve 34′ and outlet valve 42′. Consequently, the motor 50, or other drive mechanism, rotatably drives the inlet valve 34′ and outlet valve 42′ at a reduced speed so that the inlet valve 34′ and outlet valve 42′ rotate one full revolution for each three reciprocations of the cam 28. It will be understood, of course, that the illustration of three notches for both the inlet valve 34′ and outlet valve 42′ is by way of example only and that more, or fewer, notches or openings in the valves may also be used.

Optionally, the valve rotation may be decelerated before each valve closure to reduce shock resulting from rapid valve closure.

A primary advantage of Applicant's fuel pump construction is that since the rotary outlet valve 42 is actively and fully controlled through the shaft 48 together with the rotary inlet valve 34, the excessive fuel compression in the chamber 14 by the previously known outlet check valves is eliminated or at least reduced, the previously known pressure fluctuations and pulsations in the fuel system, and especially in the fuel rail 24, are reduced together with the noise (sound and vibration) caused by such pressure pulsations. Furthermore, the inlet valve and outlet valve merely rotate in their valve seats in the fuel pump housing which completely eliminates the impact noise of the previously known fuel pump valves as they open and close.

A still further advantage of the invention is that the precise opening and closing of both the inlet and outlet of the pump chamber can be completely controlled by one motor.

A still further advantage of the present invention is that, since the rotation of the inlet and outlet valves are absolutely synchronized, when the inlet valve is open, the outlet valve is closed and vice versa.

Having described our invention, however, many modifications thereto will become apparent to those skilled in the art to which it pertains without deviation from the spirit of the invention as defined by the scope of the appended claims.

We claim:

1. A fuel pump comprising:
a housing defining a pump chamber having an inlet and an outlet,
a piston reciprocally slidably mounted in said pump chamber,
an inlet valve mounted fluidly in series between said pump chamber and said housing inlet which opens and closes said inlet in synchronism with reciprocation of said piston,
a rotary outlet valve mounted fluidly in series between said pump chamber and said housing outlet, said rotary outlet valve being rotatably driven in synchronism with reciprocation of said piston and fluidly open only at one or more predetermined angular positions of said rotary outlet valve.

2. The fuel pump as defined in claim 1 where said inlet valve comprises a rotary inlet valve mounted fluidly in series with said housing inlet, said rotary inlet valve being rotatably driven in synchronism with reciprocation of said piston, said inlet valve being fluidly open and said outlet valve being fluidly closed only at one or more first predetermined angular positions of said rotary inlet valve and wherein said inlet valve is closed and said outlet valve is open only at one or more second predetermining angular positions of said rotary valve, said first predetermined angular positions being different than said second predetermined angular positions.

3. The fuel pump as defined in claim 2 wherein said rotary inlet valve and said rotary outlet valve are mechanically coupled together.

4. The fuel pump as defined in claim 2 and comprising a shaft extending between and attached to both said rotary inlet valve and said rotary outlet valve.

5. The fuel pump as defined in claim 4 wherein said shaft extends through said pump chamber.

6. The fuel pump as defined in claim 5 wherein said piston includes a slot through which said shaft extends.

7. The fuel pump as defined in claim 1 and comprising a controllable motor to rotatably drive said rotary outlet valve.

8. The fuel pump as defined in claim 7 wherein said motor comprises a DC servo motor.

9. The fuel pump as defined in claim 7 wherein said motor comprises a stepping motor.

10. The fuel pump as defined in claim 1 wherein said rotary outlet valve comprises a cylindrical valve body rotatably mounted in a recess in said housing, said valve body having at least one radially inwardly and axially extending recess which registers with both said pump chamber and said housing outlet only at predetermined angular position(s) of said rotary outlet valve.

11. The fuel pump as defined in claim 10 wherein said rotary outlet valve has at least two axially extending and circumferentially spaced recesses each of which registers with both said pump chamber and said housing outlet at at least two predetermined and circumferentially spaced angular position(s) of said rotary outlet valve.

12. The fuel pump as defined in claim 10 wherein said valve opening comprises an opening extending radially inwardly from an outer circumference between two angular positions of said rotary outlet valve.

13. The fuel pump as defined in claim 12 wherein said opening is curved.

14. The fuel pump as defined in claim 2 wherein said rotary inlet valve comprises a cylindrical valve body rotatably mounted in a recess in said housing, said valve body having at least one axially extending opening which registers with both said pump chamber and said housing inlet only at predetermined angular position(s) of said rotary inlet valve.
